(19) United States
(12) Patent Application Publication
(10) Pub. No.: US 2025/0378658 A1
(43) Pub. Date: Dec. 11, 2025

(54) CONTENT-DRIVEN VIEWING ENVIRONMENTS

(71) Applicant: Apple Inc., Cupertino, CA (US)

(72) Inventors: Suresh Koppisetty, San Jose, CA (US); Jeremy S. Jones, Santa Clara, CA (US); Eric W. Gillum, Sunnyvale, CA (US); Joshua D. Carter, Glendale, CA (US)

(21) Appl. No.: 19/229,464

(22) Filed: Jun. 5, 2025

Related U.S. Application Data
(60) Provisional application No. 63/657,656, filed on Jun. 7, 2024.

(51) Int. Cl. G06T 19/00; G06F 3/01

(52) U.S. Cl. CPC G06T 19/006; G06F 3/011; G06T 2200/24

(57) ABSTRACT

Some implementations disclosed herein enable customization of an XR environment for time-based content (e.g., a video) that is presented therein. This may involve altering or otherwise customizing an XR environment in which a video content item is viewed based on metadata stored in the video content item. The metadata may provide one or more additional timed tracks (or other synchronization data) that the device interprets to customize the environment during playback. For example, a player on the device may play image track content of a video while interpreting an environment customization track to send messages at defined playback times to the device's operating system or other component that provides views of the environment to alter or customize that viewing environment during that playback. Such messages may be directed to particular objects or actions that are exposed for video content item control by the environment or software that provides the environment.

### CROSS-REFERENCE TO RELATED APPLICATIONS

This application claims the benefit of U.S. Provisional Application Ser. No. 63/657,656 filed Jun. 7, 2024, which is incorporated herein in its entirety.

### TECHNICAL FIELD

The present disclosure generally relates to electronic devices, and in particular, to systems, methods, and devices that enable viewing of content items (e.g., videos, movies, pictures, etc.) on head-mounted devices (HMD) and other electronic devices.

### BACKGROUND

HMDs are used to view pictures, movies and other content items. In some cases, such content is provided in views such that the content appears to be on a virtual screen positioned at a 3D position (e.g., 10 feet in front of the user) along with or within other content, e.g., within a surrounding 3D environment.

### SUMMARY

Some implementations disclosed herein enable customization of an extended reality (XR) environment for time-based content (e.g., a video) that is presented therein. This may involve altering or otherwise customizing an XR environment in which a video content item is viewed based on metadata stored in the video content item. The metadata may provide one or more additional timed tracks (e.g., environment customizations with synchronization data) that the device interprets to customize the environment during playback. For example, a player on the device may play image track content of a video while interpreting an environment customization track to provide a view of the customized environment with the image track content presented at a position (e.g., on a virtual screen) within that environment. Based on the environment customization data within the content item, a player may send messages at defined playback times to the device's operating system (OS) or other component that provides views of the environment to alter or customize that viewing environment during that playback. Such messages may be directed to particular viewing environment objects or actions that are exposed for video content item control by the environment or software that provides the environment (e.g., the OS, an environment app, etc.).

Some implementations disclosed herein provide a method via one or more processors executing instructions stored in a non-transitory computer-readable medium to perform operations. The method may involve obtaining a video content item comprising a plurality of tracks. A first track of the plurality of tracks may specify (e.g., provide) image content frames for playback according to a playback timeline. A second track of the plurality of tracks may specify (e.g., provide) environment customization information for use according to the playback timeline.

The method may present views of an XR environment based on the first track, the second track, and an environment appearance. For example, the environment appearance may be a defined virtual 3D scene configured to provide an immersive environment on an XR viewing device such as an HMD. In one example, an environment appearance may correspond to a default or static viewing environment (e.g., a view of a 3D environment presenting a room such as a theater). In another example, the environment appearance may be a view of passthrough video of a 3D physical environment provided by an XR viewing device such as an HMD. In another example, the environment appearance may be a combination of the two, e.g., with certain portions of the viewing environment appearance corresponding to a virtual scene and other portions of the viewing environment appearance corresponding to a physical environment.

Presenting the views of the XR environment may involve presenting the image content frames of the first track according to the timeline. The image content frames may be presented at a playback region (e.g., on virtual 2D screen) positioned within a three-dimensional (3D) coordinate system of the XR environment, e.g., a movie may be presented on a virtual 2D screen at a position within a 3D space. Presenting the views of the XR environment may additionally involve presenting a viewing environment with (e.g., around) the image content frames. The viewing environment may be presented based on customizing one or more characteristics (e.g., objects or actions) of the environment appearance based on the environment customization information of the second track. Presenting image content frames and customizing characteristics of environment appearance may be synchronized according to the playback timeline.

In some implementations, a video content itself stores information that coordinates the presentation of image, audio, and/or viewing environment configuration in a time-synchronized manner. Such synchronization information, e.g., the use of tracks associated with a common timeline, may be generated when the video content is recorded, animated, or otherwise generated, or may be added after such generation, e.g., by adding an additional environment customization track to a video's existing image/audio track set.

Examples of environment configurations include, but are not limited to: (a) day/night transitions; (b) swapping textures of objects, walls, etc.; (c) changing a type of an environment object (e.g., dog or cat); (d) changing the position, size, shape, changing the position, size, or shape of an object; (e) changing the position, size, shape, or aspect ratio of the virtual screen upon which image/video content is presented; (f) making hidden 2D or 3D content/objects visible; (g) providing content instead of the videos image/video content for a period of time; and (h) defining which users (e.g., in the case of shared viewing) are enabled to change the environment objects/actions. Additional examples are described herein.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example physical operating environment in accordance with some implementations.

FIG. 2 illustrates a view of the environment of FIG. 1 provided by an electronic device in accordance with some implementations.

FIG. 3A-3C illustrate an electronic device providing views of different content frames of a video content item within a content-driven XR environment, in accordance with some implementations.

FIG. 4A-4C illustrate an electronic device providing views of different content frames of a video content item within a content-driven XR environment, in accordance with some implementations.

FIG. 5A-5C illustrate an electronic device providing views of different content frames of a video content item within a content-driven XR environment, in accordance with some implementations.

FIG. 6A-6C illustrate an electronic device providing views of different content frames of a video content item within a content-driven XR environment, in accordance with some implementations.

FIG. 7 is a flowchart illustrating an exemplary method of providing image content of a video content item within a content-driven viewing environment, in accordance with some implementations.

FIG. 8 illustrates an exemplary computing device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

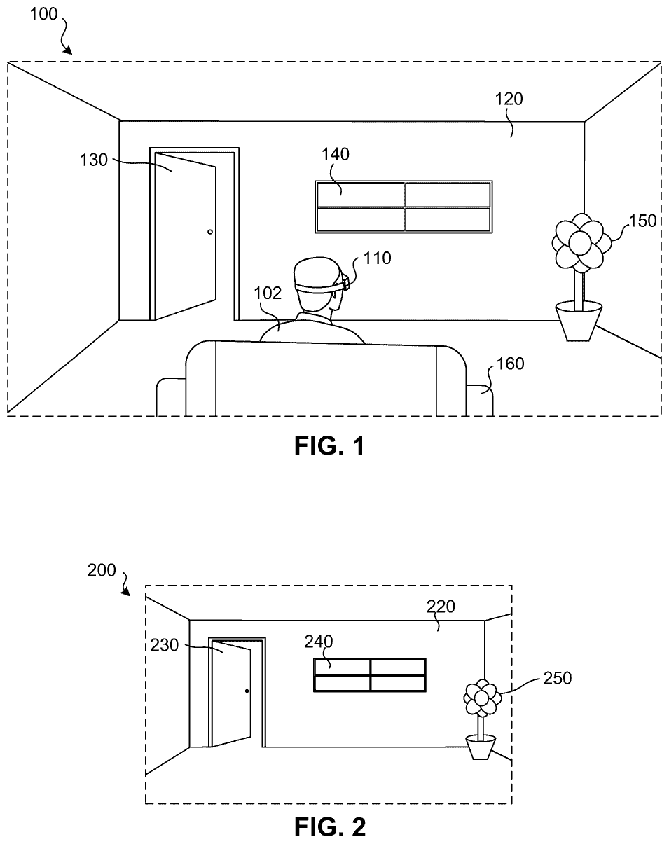

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein. While FIG. 1 depicts exemplary implementations involving a head mounted device (HMD), other implementations do not necessarily involve an HMD and may involve other types of devices including, but not limited to, watches and other wearable electronic devices, mobile devices, laptops, desktops, gaming devices, home automation devices, and other types of user devices.

FIG. 1 illustrates an example physical environment 100 in which a device, such as device 110, may provide views in accordance with some implementations. In this example, physical environment 100 includes walls (such as wall 120), a door 130, a window 140, a plant 150, and a sofa 160.

The electronic device 110 may include one or more cameras, microphones, depth sensors, or other sensors that can be used to capture information about and evaluate the physical environments 100 and the objects therein, as well as information about the user 102. The device 110 may use information about its physical environment 100 or user 102 that it obtains from its sensors to provide visual and audio content.

In some implementations, the device 110 is configured to present views that it generates to the user 102, including views that may be based on the physical environment 100 and one or more virtual content items, e.g., a video content item. According to some implementations, the electronic device 110 generates and presents views of an extended reality (XR) environment.

In some implementations, the device 110 is a handheld electronic device (e.g., a smartphone or a tablet). In some implementations, the user 102 wears the device 110 on his/her head. As such, the device 110 may include one or more displays provided to display content. For example, the device 110 may enclose the field-of-view of the user 102.

In some implementations, the functionalities of device 110 are provided by more than one device. In some implementations, the device 110 communicates with a separate controller or server to manage and coordinate an experience for the user. Such a controller or server may be local or remote relative to the physical environment 100.

FIG. 2 is a view 200 depicting the physical environment 100 provided by the device 110 of FIG. 1. In this example, the view 200 is a view of an XR environment that depicts and enables user interactions with real or virtual objects. Such a view may include optical see through or pass-through video providing depictions of portions of the physical environment 100. In one example, one or more outward facing cameras on device 110 capture images of the physical environment that are passed through to provide at least some of the content depicted in the view 200. In this example, the view 200 includes depictions of the walls, such as depiction 220 of wall 120, depictions of the floor and ceiling, a depiction 230 of the door 130, a depiction 240 of the window 140, and a depiction 250 of the flower 150.

The device 110 may be configured to display one or more video content items, e.g., on a virtual screen, within a view provided by the device 110. A video content items may be presented at a 3D position within an XR environment. In such a view, the surrounding environment may be all physical, e.g., displaying a view of the physical environment 100 around the virtual screen, virtual, e.g., displaying an entirely immersive virtual scene around the virtual screen, or a combination of physical and virtual environment portions.

Some implementations change aspects of an environment appearance (e.g., physical, virtual, or both) over time during the playback of a video content item. The customization of the environment appearance may be controlled or influenced by information (e.g., environment customization track(s) or other metadata) that is stored within video content item itself. The customization of the environment may additionally account for one or more users, e.g., users in a shared viewing experience or a communication-based (e.g., co-presence) experience. In some implementations, default environment appearance parameters are established and one or more of such parameters are altered by one or more users in such a shared experience or communication session.

In some implementations changes of an environment appearance account for user condition, e.g., changing the environment based on whether the user is sitting down, tired, watching with others, engaged in multiple activities, etc. In some implementations, a device (e.g., an HMD) includes sensors that capture images or other sensor data corresponding to the user's eyes and the areas around the user's eyes (e.g., gaze direction, expressions, skin wrinkles, squinting, etc.) within the eye-box of the HMD. Such eye and face information may be used to determine user gaze, user condition, user emotion, etc., which may be used to customize environment appearance, e.g., within content-specified appearance parameter specifications or ranges. For example, the content may specify a virtual screen size for a particular content frame of at least a particular size (e.g., 9 feet) and the system may select a size above that size according to the users involved in a shared viewing session, e.g., selecting a very large size at a relatively distant position based on the presence of a large number of users in the shared experience.

Some implementations involve a video content item that identifies a type of viewing environment in which the video will be presented. For example, a movie about aliens may have metadata that identifies or otherwise specifies that the movie will be presented in a dark environment, an environment representing a moon setting, an environment having a star-filled sky, on an alien terrain/landscape, etc. A device may be configured to interpret the video content item, including its metadata, to identify an appropriate viewing environment in which to present the video content item. In some implementations, the video content item identifies a specific environment, e.g., moon surface environment version A versus moon surface environment version B. In some implementations, the video content item identifies a characteristic or attribute, e.g., space, dark, science fiction, etc., and the viewing device selects an appropriate viewing environment based on the identified characteristic or attribute, e.g., selecting moon surface environment version A based on the content item identifying that the scene relates to “space” and “dark.”

In some implementations a video content item stores environment content, e.g., images, video clips, audio clips, etc. that are used in presenting a viewing environment. For example, a video content item relating to a science fiction space exploration movie involving an alien planet with a red sky may provide 2D or 3D content (e.g., environment images or 3D environment info) from which a viewing environment may be provided having a red sky. Such environment content may be derived from but stored separately from the image content of the video content item. For example, a video content item may identify a network storage location at which such environment source images/3D data may be obtained.

In some implementations, a video content item includes metadata that indicates that the viewing environment will change during the course of playback of the video content item. For example, the video content item may specify that a first viewing environment will be used for an initial scene, time-segment, episode, season, etc. and a second, different viewing environment will be used for a second scene, time-segment, episode, season, etc.

In some implementations, a video content item includes information that selects a viewing environment from a set of available viewing environments, e.g., by providing an identifier corresponding to a selected viewing environment. The video content item may include multiple viewing environment selections to provide different viewing environments for different portions (e.g., time segments) of the video playback. In some implementations, a viewing environment track identifies a viewing environment to be used during such different time segments, e.g., by identifying frames at which environment changes will occur, groups of frames/time segments at which particular environments or environment customizations will apply, etc.

Some implementations provide metadata for a video item content that enables the device to configure a known or unknown viewing environment. For example, such metadata may specify characteristics of objects or actions within a viewing environment. In some implementations, an environment comprises (and exposes for customization) a set of 3D objects (e.g., walls, floors, ceilings, lights, furniture, windows, appliances, fixtures, trees, rocks, ground surfaces, sky appearances (e.g., lighting, clouds, weather, etc.), virtual characters, etc.) that can be configured (during the course of video content item playback) to appear, disappear, move, change size or shape, change type (e.g., dog to cat), change color, lighten/darken, produce sound, or otherwise change. A video content item may specify environment viewing customizations that enhance the viewing experience of different scenes within the content, e.g., making the environment during scary scenes creepy, making the environment during natural scenes feel natural, making the environment during alien scenes feel alien, etc.

Some implementations utilize tracks which provide timing (e.g., timestamp) information that enables synchronizing environment customizations with the playback of particular image content frames of a content item. For example, the video content item may include multiple tracks that each identify respective items (e.g., video image frames and environment configurations, respectively) that will occur at particular times during the content playback timeline.

In some implementations, an environment comprises (and exposes for customization) a set of actions that can be configured to occur, e.g., during the course of video content item playback. Such actions may be association with one or more objects that are provided by the environment. A video content item may include viewing environment information that calls such actions. For example, a movie may have a viewing environment track that specifies configuring the environment to provide explosion effects (e.g., actions) at the same time an explosion occurs within the movie's playback. The video content player may interpret such information to cause the environment appearance to display the explosion. For example, if the environment is provided by the device's operating system (or other device software), the video content player may send a message to the operating system or device software to trigger the change/customization of the environment at the appropriate time during playback.

In some implementations, an environment exposes a set of objects and a set of actions and provides names or other identifiers that may be used (e.g., within a video content item) to customize the appearance of the environment by referring to particular objects and actions. For example, a video content item may specify that at time 100, a butterfly (e.g., identified object) in the viewing environment will fly (e.g., identified action). The object (e.g., butterfly) and action (e.g., fly) may be built into the environment such that the video content item need only specify the object and action and need not include additional details. Alternatively, the video content item may specify details, e.g., by identify a flight destination, flight length, flight path, etc. for the butterfly in the above example.

In some implementations, an environment includes a viewing position for a virtual screen upon which the video content item is played. Configurable aspects of the environment may include the position, size, shape, aspect ratio, or other attributes of the viewing screen. Thus, a video content item may include customization information that specifies the position (e.g., docking position), orientation, size, shape, aspect ratio or other attributes of the viewing screen and changes to such attributes that may be customized overtime during playback of the video content item. For example, a video content item may specify that the video is to be displayed on an 8 foot×4.5 foot virtual screen that is 10 feet in front of the user's viewpoint position in the 3D environment during a first scene and then on a 20 foot×8 foot virtual screen that is 15 feet in front of the user's viewpoint position in the 3D environment during a second scene.

Some implementations provide video content items that specify environment customizations that include, but are not limited to, day/night transitions, swapping textures, changing the type of an environment object, changing positions or other attributes of environment objects or the virtual screen upon which the video content item is presented.

Content item creators may be empowered to generate new and better experiences for viewing video content items. For example, content creators may be empowered to specify viewing environment appearance characteristics during the course of playback of their video content items in ways that enhance the viewing experience. An existing video content item may be enhanced (e.g., by adding viewing environment configuration information) to customize the viewing environment of that video content item. New video content item creations may be created with environment customizations in mind and specified at the time of creation and thus the content creator may produce video scenes taking into account this additional degree of control, e.g., utilizing the viewing environment to influence the experience in addition to or instead of using the video image content itself. For example, leading up to the time a villain will enter the video content from a left side in a movie, the viewing environment may be customized with subtle motion of environment objects on the left side of the user's field of view to heighten the viewer's anticipation that something is happening over to the left in the movie scene.

Video content items may be configured so that the video content images (e.g., the image track) do not play continuously. For example, for a short period of time, the video (e.g., the virtual screen upon which the video content is displayed) may disappear, leaving the viewer to experience just the viewing environment. The video content may reappear in the same or a different location at a later point in time. In another example, the video content may be replaced for a period of time with different content, such as a 3D experience. In another example, video content is supplemented for a period of time with additional content, such as a 3D object presented off to the side of the video content and corresponding to an item being presented in the video content at that time. For example, the characters in a movie may be looking at a globe of the earth and discussing a path that they will take on a journey. During presentation of this scene, a 3D representation of the globe that the characters are discussing may be presented off to one side (or elsewhere) of a virtual screen upon which the video content is presented. The 3D representation may include animations, e.g., animating the path that the characters are planning, rotating, zooming, etc. In this example, such additional content and customization information regarding how it will be displayed with the video content may be included within the video content itself, e.g., as metadata.

In some implementations, a video content item specifies sets of objects and sets of actions corresponding to those actions to be included in an environment. The video content item may then specify customizations of the viewing environment to be applied during playback of the video content item using those objects and actions. The video content item may specify such sets in various ways, e.g., by including image and action data within the video content item itself, or by referencing separately stored information, for example, accessible via a cloud storage or other downloadable network location.

In some implementations, a video content item specifies use of a particular environment (e.g., type of environment, predefined environment, etc.) that is associated with predefined sets of objects and actions. The player interprets the video content item and facilitates playback within the specified environment. For example, the player may send a message to the device's operating system to cause the device to download, access, or use the specified environment. The video content item may further provide customizations (e.g., over time during playback) of the specified environment. For example, the video content item may include metadata such as a viewing environment customization track that specifies the locations, orientations, sizes, transformations, or other actions for the objects defined or otherwise exposed for a particular environment. This information may be accessed by the player and used to generate messages to produce the desired results, e.g., sending messages to the operating system or other device software to cause the desired customizations to the objects and trigger the various actions that the operating system or other device software exposes for such customizations.

A video content item may specify viewing environment sounds. For example, it may specify spatialized environment sounds that are produced via a spatialized audio device (e.g., spatialized speaker) such that the user perceives the sounds as coming from particular locations around the user within a 3D viewing environment. The video content item may customize the viewing environment by providing sounds in the periphery of the user's field of view or outside the user's field of view to provide an intended viewing experience. In one example, before a villain enters a scene from the left side, spatialized audio in the viewing environment may provide sounds that are perceived as coming from positions in the 3D environment off to the left side of a virtual screen upon which the video content is being presented.

In some implementations, a video content item player is configured to play video content items in different ways depending upon device capabilities, content-specified viewing environment information, user preferences, or other information. A player may be configured, for example, to play a video content item within an immersive space that a particular device provides for viewing video content items, e.g., within a virtual theater that that device/platform uses as a preferred, default, or required viewing environment. In another example, the player may be configured to use such an environment as a default but, if permitted, utilize a different environment specified by a content item, user, or otherwise. A player may identify, access, or download an appropriate viewing environment based on information specified by a content item, a user, or otherwise.

In some implementations, a video content item identifies a viewing environment for viewing the video content item, for example, by including a viewing environment identifier, name, or storage location. The viewing environment for viewing that video content item may be changed by changing that identifier, e.g., via a relatively simple modification to the video content item itself. In another example, an existing video content item that does not specify a viewing environment may be modified to add or otherwise reference a viewing environment to be used when viewing the video content item, e.g., via the relatively simple addition of the name, identifier, location, etc. of the viewing environment.

In some implementations, a video content item is manually supplemented with time-varying viewing environment configuration information, e.g., via a person manually identifying times within the video content playback (e.g., along its timeline) at which particular environments or environment appearance characteristics will be used. A user interface tool may provide a way for a video content editing user to generate multiple tracks associated with a playback timeline, specifying viewing environment customizations along the track. Such a user interface may present mockup views of the video content item within the configured viewing environment to enable the user to see how the specified customization will appear during playback, e.g., combining the video content with the viewing environment in views that are used to enable the user to envision how end users will experience the item. The editing view may, for example, be based on a default viewpoint within the viewing environment and may provide only a single eye view.

In some implementations, such supplemental information is automatically generated, e.g., without necessarily involving user involvement or with minimal user involvement. For example, a video content item may be inspected via a software process or machine learning model to determine one or more scene classifications (e.g., day, night, indoor, outdoor, residence, business, forest, lake, seashore, farmland, urban, rural, waterfall, rocky terrain, alien terrain, sunny, rainy, snowing, snow-covered terrain, wet terrain, etc.) that are applicable to each scene in the video content item. These one or more classifications may be included as metadata within a content item and used by a content player to select or configure a viewing environment for each scene. In another example, such one or more classifications may be used, e.g., by a manual or automatic process, to select or configure a viewing environment for each scene and scene selection or environment configuration information may be included in the video content item, e.g., in a viewing environment track or other metadata.

In some implementations, streaming video content is viewed within a viewing environment. Such video content may include attribute/classification information or information regarding scene-specific/time specific viewing environment selections and configurations. For example, as streaming content is captured via a video capture device, a process may execute to inspect the content that is occurring to determine attribute/scene classification information and use that information to specify the viewing environment customizations, e.g., by providing the attributes identified via the classification or adding scene selections and customizations determined therefrom. In one example, a live-streamed soccer game may be inspected and particular events identified (e.g., goals being scored, shots being blocked, fouls being called, etc.) and these events or viewing environment customizations corresponding to these events may be included in metadata that is streamed along with the image content.

Some implementations provide customizations of viewing environments that correspond to physical environments around viewers. For example, an XR reality environment may present a virtual screen with video content within a view of a user's actual physical environment, e.g., where the actual physical environment is viewed via passthrough video—e.g., video captured by outward facing cameras on an HMD that is relayed in near real time for viewing within the HMD. Some implementations customize such a viewing environment. Such customizations may involve changing the tint, color, brightness, or other characteristics of the passthrough according to viewing environment customization information stored within a content item. Such customizations may add virtual content, augmentations, or effects in the environment to provide an altered version of the physical environment, e.g., adding fireworks, adding stars, adding rain, changing the appearance of the sky from nighttime to daytime, replacing the floor with lava, etc.

In some implementations a video content item specifies a first viewing environment customization for virtual/immersive viewing environments and a second viewing environment customization for physical/passthrough viewing environments. In some cases, a user's viewing environment will include both virtual/immersive viewing environment portions and physical/passthrough viewing environment portions. Each such portion may be customized according to content-driven environment customizations specified for its respective viewing environment type.

Some implementations provide viewing environment customizations at scene transitions, e.g., providing a fade to back when a scene ends that blacks-out the entire viewing environment during the transition. Such transitions may provide a time buffer to enable new viewing environments to load or for viewing environment customizations for the subsequent scene to be applied.

Some implementations provide fast-forward, skip, or rewind functions during playback of a video content item within a viewing environment in which the viewing environment customizations specified in the video content item are synchronized. Thus, if a user rewinds playback of the video content item to a prior scene that is associated with a different viewing environment customization state than the current scene, the video content item can cause appropriate changes to the viewing environment. For example, this may involve detecting a command to rewind, fast-forward, or skip command, identifying a point on a playback timeline based on the command, and then identifying appropriate customizations to apply based on the identified point. In a specific example, if the user rewinds 5 minutes, the system may identify the point along the timeline and send messages to the operating system or other device software to cause it to reinitialize the viewing environment and perform all customizations up until the point (e.g., all the customizations specified in the customization track up until the point in time 5 minutes prior to the starting playback point). In an alternative example, the player or device may identify timestamp environment events at which objects appear, objects disappear, objects change, or actions are performed on objects and lengths of time associated with changes or actions that are performed, and determine the state of the viewing environment by interpolating between states at known times of the environment presentation. In an alternative example, the player stores information about the viewing environment during each point (e.g., each frame) of playback and this frame specific state information is used to facilitate rewind, fast-forward, and skipping functions.

In some implementations multiple users (e.g., each with their own HMD) view the same video content item at the same time, e.g., in a shared play session in which each user's device presents views in which the video content item is played and the playback of the video content item on the devices is synchronized. If the users are in the same physical or virtual environment, the playback may be positionally aligned (e.g., on the same virtual screen at the same position within the 3D coordinate system of that environment). In one example, when one user initiates playback of a video content item, the user's device sends one or more messages to the second user's device to synchronize playback, coordinate virtual screen positioning, or coordinate viewing environment customizations. Such customizations may be controlled by the content item itself or one or both of the users.

In some implementations, the viewing environment changes based on the number of people involved in a shared play session. For example, a virtual theater viewing environment may have a first width and length when one viewer is watching, a second, larger width and length when two viewers are watching, a third larger width and length when three viewers are watching, etc.

In some implementations, a video content item specifies viewing environment customization that depend upon contextual information such as the number of viewers involved in a shared play session, the time of day during playback, the locations of the viewers, the preferences of the viewers, the types of devices used by the viewers, the audio or video capabilities of the devices used by the viewers, etc.

In some implementations, a shared play session involves multiple viewers simultaneously viewing the same video content item within different viewing environments, e.g., each may view within a different virtual environment or a different physical/passthrough environment. A coherence process may be applied to provide common viewing environment characteristics in various circumstances. For example, such a process may identify viewing environment customizations that will be applied and ensure that they are applied in a way that provides a shared user experience.

Viewing environment information stored in a video content item may specify that if the video content item is viewed in a shared play session, the viewing environment must be the same. Thus, the players involved in playing the video may enforce such a requirement, e.g., by requiring the playback environment be the same virtual environment or that one device share its physical environment with the other so that the other device can replicate that physical environment and any content or user-device specified viewing environment customizations applied thereto.

In some implementations a shared viewing environment can be interacted with or modified by one or more of the users involved in the experience. Changes made to the environment by one user may be implemented in the other user environments, e.g., when one user virtually moves a rock on the ground the rock moves in the other user's view of the viewing environment. A coherence model may be used to manage state, e.g., enforcing a rule that last interaction with an object “wins” or that one user is given primary or prioritized control over viewing environment interactions. A viewing environment may be implemented via a state model that tracks object states over time and such state information may be managed by a collaboration engine or coherence process to ensure consistency over time and on multiple devices.

In some implementations a first user initiates playback of a video content item and another user joins the first user at a later point in time, e.g., 10 minutes into playback. The second user's viewing environment may be implemented in a way that catches up to the first user's viewing environment, e.g., applying any content-specified customizations occurring already and applying any user changes occurring already.

In some implementations during a shared play session, a content item specifies a user's ability (or multiple users in the case of shared play sessions) to change a viewing environment during playback. For example, a first video content item may enable a user to change virtual screen position while a second video content item may restrict such a change.

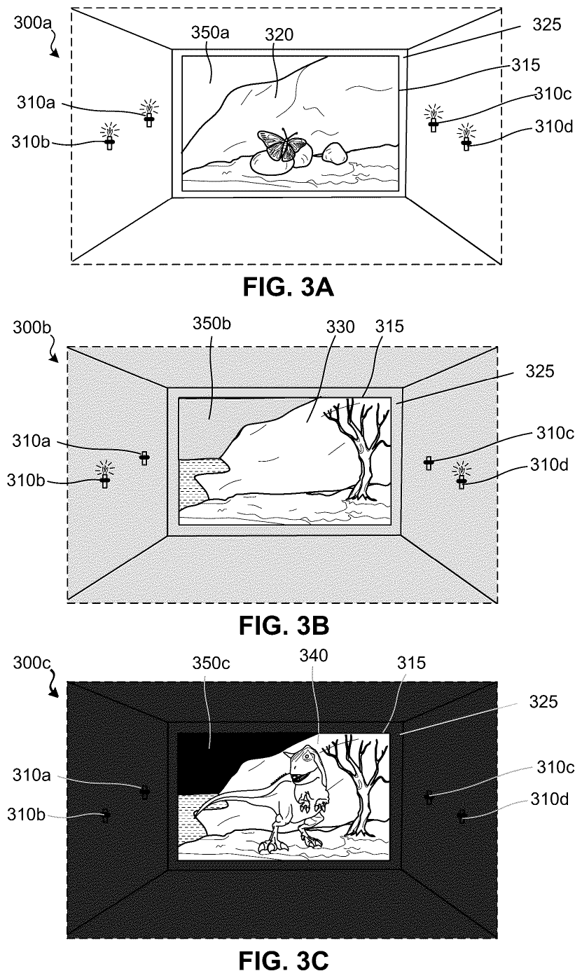

FIG. 3A-3C illustrate an electronic device (such as the electronic device 110 of FIG. 1) providing views 300a-c of different content frames 320, 330, 340 of a video content item within a content-driven XR environment. These views 300a-c include a virtual viewing environment that replaces the appearance of the user's physical environment, e.g., as depicted in FIG. 2. The viewing environment includes objects (e.g., walls, such as back wall 325, forming a room and torches 310a-d) and actions (e.g., changes in object appearance, changes in lighting, movements of objects such as movements of the torches 410a-d, etc.) that are customized by the video content item. The video content item includes metadata (e.g., a viewing environment track) that is used in providing the views 300a-c to customize that viewing environment during different playback times, e.g., for the different frames 320, 330, 340, during playback of the video content item within the viewing environment.

In this example, metadata of the video content item specifies that the appearance of the viewing environment corresponding to the first frame 320 will have a default configuration associated with the viewing environment, e.g., in which the walls are plain (e.g., untextured), the torches 310a-d have default positions and default conditions (e.g., lit versus not lit), and the viewing environment has a first illumination state (e.g., fully lit). Use of the default configuration may be content provider specified or automatically determined, for example, based on the content of the first frame 320, e.g., based on characteristics of the sky 350a depicted in the first frame 320 corresponding to daytime. According to the default viewing environment configuration, the view 300a presents the first frame 320 within a virtual screen 315 on the back wall 325, with the walls shown as plain (e.g., untextured), the torches 310a-d in their default positions and lit, and the viewing environment having the first illumination state (e.g., fully lit).

In this example, metadata of the video content item specifies that the appearance of the viewing environment corresponding to the second frame 330 (which does not necessarily correspond to the frame immediately following first frame 320) will have a customized configuration associated with the viewing environment, e.g., in which the walls are plain (e.g., untextured), the torches 310a-d have default positions and customized conditions (e.g., some lit, some not lit), and the viewing environment has a second illumination state (e.g., partially lit). Use of this customized configuration may be content provider specified or automatically determined, for example, based on the content of the second frame 330, e.g., based on characteristics of the sky 350b depicted in the second frame 330 corresponding to dusk. According to the default viewing environment configuration, the view 300b presents the second frame 330 within the virtual screen 315 on the back wall 325, with the walls shown as plain (e.g., untextured), the torches 310a-d in their default positions and customized conditions (e.g., some lit, some not lit), and the viewing environment having the second illumination state (e.g., partially lit).

In this example, metadata of the video content item specifies that the appearance of the viewing environment corresponding to the third frame 340 (which does not necessarily correspond to the frame immediately following second frame 330) will have a customized configuration associated with the viewing environment, e.g., in which the walls are plain (e.g., untextured), the torches 310a-d have default positions and customized conditions (e.g., not lit), and the viewing environment has a third illumination state (e.g., dark). Use of this customized configuration may be content provider specified or automatically determined, for example, based on the content of the third frame 340, e.g., based on characteristics of the sky 350c depicted in the third frame 340 corresponding to night. According to the viewing environment configuration, the view 300c presents the third frame 340 within the virtual screen 315 on the back wall 325, with the walls shown as plain (e.g., untextured), the torches 310a-d in their default positions and customized conditions (e.g., not lit), and the viewing environment having the third illumination state (e.g., dark).

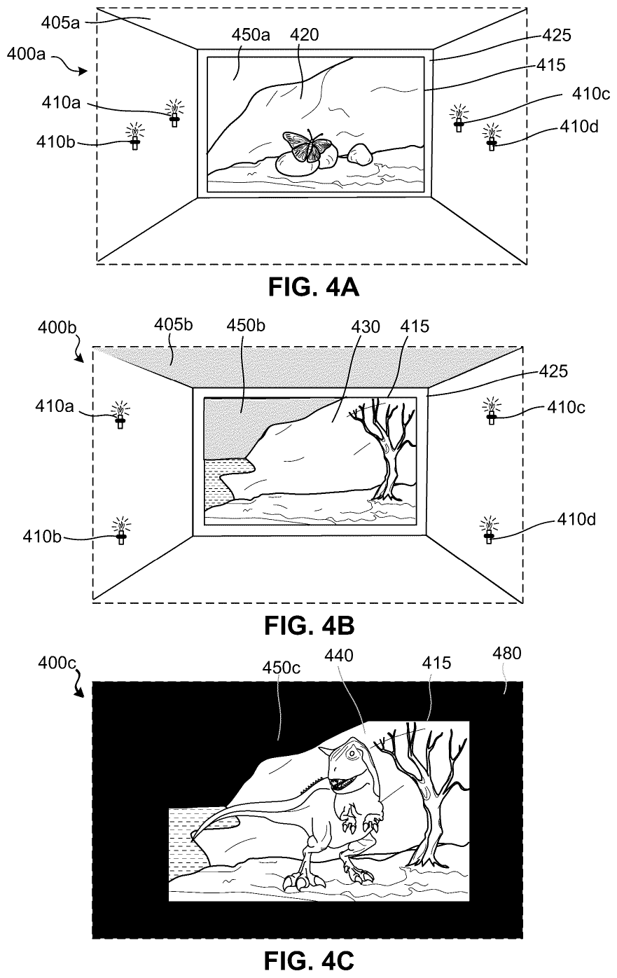

FIG. 4A-4C illustrate an electronic device (such as the electronic device 110 of FIG. 1) providing views 400a-c of different content frames 420, 430, 440 of a video content item within a content-driven XR environment. These views 400a-c include a virtual viewing environment that includes objects (e.g., walls, such as ceiling 405a and back wall 425, forming a room and torches 410a-d) and may involve actions (e.g., changes in object appearance, changes in lighting, movements of objects such as movements of the torches 410a-d, etc.) that are customized by the video content item. The video content item includes metadata (e.g., a viewing environment track) that is used in providing the views 400a-c to customize that viewing environment during different playback times, e.g., for the different frames 420, 430, 440, during playback of the video content item within the viewing environment.

In this example, metadata of the video content item specifies that the appearance of the viewing environment corresponding to the first frame 420 will have a default configuration associated with the viewing environment, e.g., in which the walls are plain (e.g., untextured), the torches 410a-d have default positions and default conditions (e.g., lit versus not lit), and the viewing environment has a first illumination state (e.g., fully lit). Use of the default configuration may be content provider specified or automatically determined, for example, based on the content of the first frame 420, e.g., based on characteristics of the sky 450a depicted in the first frame 320 corresponding to daytime. According to the default viewing environment configuration, the view 400a presents the first frame 420 within a virtual screen 415 on the back wall 425, with the walls, including ceiling 405a, shown as plain (e.g., untextured), the torches 410a-d in their default positions and lit, and the viewing environment having the first illumination state (e.g., fully lit).

In this example, metadata of the video content item specifies that the appearance of the viewing environment corresponding to the second frame 430 (which does not necessarily correspond to the frame immediately following first frame 420) will have a customized configuration associated with the viewing environment, e.g., in which the walls are customized (e.g., some walls are untextured but ceiling 405b is customized with a texture—a grey color), the torches 410a-d have default customized positions (e.g., different than there default positions-vertical alignment rather than horizontal alignment), and the viewing environment has the same first illumination state (e.g., fully lit). Use of this customized configuration may be content provider specified or automatically determined, for example, based on the content of the second frame 430, e.g., based on characteristics of the sky 450b depicted in the second frame 430 corresponding to dusk. According to the viewing environment configuration, the view 400b presents the second frame 430 within the virtual screen 415 on the back wall 425, with some walls shown as plain (e.g., untextured) and the ceiling shown with texture—a grey color, the torches 410a-d in customized positions (e.g., vertically aligned rather than horizontally aligned), and the viewing environment having the first illumination state (e.g., fully lit). Note that the customized positions or movements of objects may be specified in various ways, e.g., by specifying properties such as alignment directions, specifying particular 3D object locations/poses, specifying movement paths that are used to move the objects over time over multiple frames, specifying object dimensions, specifying actions that are exposed for the objects of the viewing environment, etc.

In this example, metadata of the video content item specifies that the appearance of the viewing environment corresponding to the third frame 440 (which does not necessarily correspond to the frame immediately following second frame 430) will have a customized configuration associated with the viewing environment, e.g., the viewing environment has a second illumination state (e.g., full darkness) in which no objects are visible in the viewing environment. Use of this customized configuration may be content provider specified or automatically determined, for example, based on the content of the third frame 440, e.g., based on characteristics of the sky 450c depicted in the third frame 440 corresponding to night. According to the viewing environment configuration, the view 400c presents the third frame 440 within the virtual screen 415 in an entirely dark viewing environment 480.

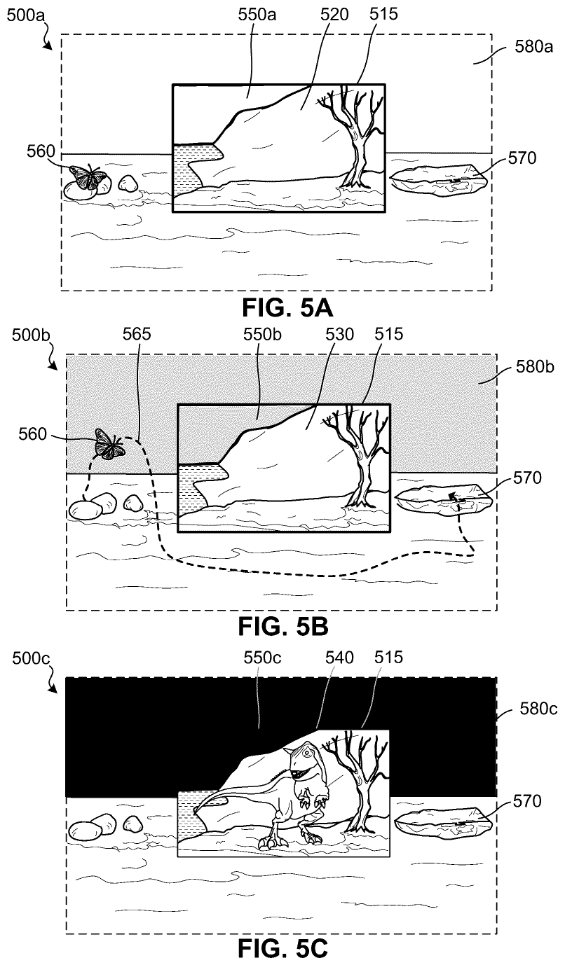

FIG. 5A-5C illustrate an electronic device (such as the electronic device 110 of FIG. 1) providing views 500a-c different content frames 520, 530, 540 of a video content item within a content-driven XR environment. These views 500a-c include a virtual viewing environment that replaces the appearance of the user's physical environment, e.g., as depicted in FIG. 2. The viewing environment includes a rocky, prehistoric terrain that includes objects (e.g., butterfly 560, rock 570, and sky 580a) and actions (e.g., changes in object appearance, changes in lighting, movements of objects such as movements of the butterfly 560, etc.) that are customized by the video content item. The video content item includes metadata (e.g., a viewing environment track) that is used in providing the views 500a-c by identifying the viewing environment and specifying customizations to that viewing environment during different playback times, e.g., for the different frames 520, 530, 540, during playback of the video content item within the viewing environment.

In this example, metadata of the video content item specifies that the appearance of the viewing environment corresponding to the first frame 520 will have a default configuration associated with the viewing environment, e.g., in which the objects (e.g., butterfly 560) have default positions and the viewing environment has a first state (e.g., daytime). Use of the default configuration may be content provider specified or automatically determined, for example, based on the content of the first frame 520, e.g., based on characteristics of the sky 550a depicted in the first frame 520 corresponding to daytime. According to the default viewing environment configuration, the view 500a presents the first frame 520 within a virtual screen 515 at a default position within the 3D environment of the rocky, prehistoric terrain, with the objects (e.g., butterfly 560) in their default positions, and the viewing environment having the first state (e.g., daytime).

In this example, metadata of the video content item specifies that the appearance of the viewing environment corresponding to the second frame 530 (which does not necessarily correspond to the frame immediately following first frame 520) will have a customized configuration associated with the viewing environment, e.g., in which objects have customized states or are performing actions (e.g., butterfly 560 is in flight along path 560) and the viewing environment has a second state (e.g., dusk). Use of this customized configuration may be content provider specified or automatically determined, for example, based on the content of the second frame 530, e.g., based on characteristics of the sky 550b depicted in the second frame 530 corresponding to dusk. According to the default viewing environment configuration, the view 500b presents the second frame 530 within the virtual screen 515, with the objects having customized states/performing actions (e.g., butterfly 560 is in flight along path 560) and the viewing environment having the second state (e.g., dusk).

In this example, metadata of the video content item specifies that the appearance of the viewing environment corresponding to the third frame 540 (which does not necessarily correspond to the frame immediately following second frame 530) will have a customized configuration associated with the viewing environment, e.g., in which objects are changed (e.g., butterfly 560 is gone) and the viewing environment has a third state (e.g., night). Use of this customized configuration may be content provider specified or automatically determined, for example, based on the content of the third frame 540, e.g., based on characteristics of the sky 550c depicted in the third frame 340 corresponding to night and presence of a creature in the content frame. According to the viewing environment configuration, the view 500c presents the third frame 540 within the virtual screen 515 with the objects altered (e.g., butterfly 560 gone) and the viewing environment having the third state (e.g., night).

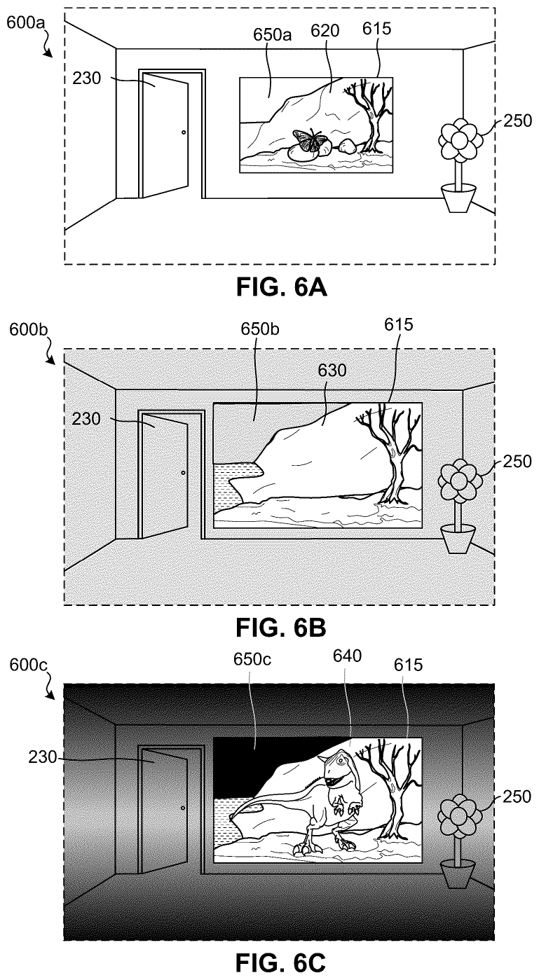

FIG. 6A-6C illustrate an electronic device providing views 600a-c of different content frames 620, 630, 640 of a video content item within a content-driven XR environment. These views 600a-c include a physical (e.g., passthrough) viewing environment that presents the appearance of the user's physical environment, e.g., as depicted in FIG. 2. The viewing environment includes objects depictions of physical environment objects (e.g., depiction 230 of door 130, depiction 250 of plant 250, etc.) that may be customized by the video content item. The video content item includes metadata (e.g., a viewing environment track) that is used in providing the views 600a-c to customize that viewing environment during different playback times, e.g., for the different frames 620, 630, 640, during playback of the video content item within the viewing environment.

In this example, metadata of the video content item specifies that the appearance of the viewing environment corresponding to the first frame 620 will have a default configuration associated with the viewing environment, e.g., in which the viewing environment matches the physical environment without customization. Use of the default may be content provider specified or automatically determined, for example, based on the content of the first frame 620, e.g., based on characteristics of the sky 650a depicted in the first frame 620 corresponding to daytime. According to the default viewing environment configuration, the view 600a presents the first frame 620 within a virtual screen 615 at a 3D position within the view of the physical environment.

In this example, metadata of the video content item specifies that the appearance of the viewing environment corresponding to the second frame 630 (which does not necessarily correspond to the frame immediately following first frame 620) will have a customized configuration associated with the viewing environment, e.g., in which the viewing environment is modified to provide an altered lighting characteristic, e.g., appearing to be darker than the actual physical environment lighting. Use of this customized configuration may be content provider specified or automatically determined, for example, based on the content of the second frame 630, e.g., based on characteristics of the sky 650b depicted in the second frame 630 corresponding to dusk. According to the default viewing environment configuration, the view 600b presents the second frame 630 within a virtual screen 615 within an altered view of the physical environment, e.g., in which the physical environment appears darker, less illuminated, etc.

In this example, metadata of the video content item specifies that the appearance of the viewing environment corresponding to the third frame 640 (which does not necessarily correspond to the frame immediately following second frame 630) will have a customized configuration associated with the viewing environment, e.g., in which the viewing environment is modified to provide a second altered lighting characteristic, e.g., presenting a varying darkening effect. Use of this customized configuration may be content provider specified or automatically determined, for example, based on the content of the third frame 640, e.g., based on characteristics of the sky 650c depicted in the third frame 340 corresponding to night. According to the viewing environment configuration, the view 600c presents the third frame 640 within the virtual screen 615 within an altered view of the physical environment, e.g., in which some portions of the physical environment appear slightly darker while other portions of the physical environment appear more significantly darker than the actual lighting conditions of the physical environment would otherwise provide.

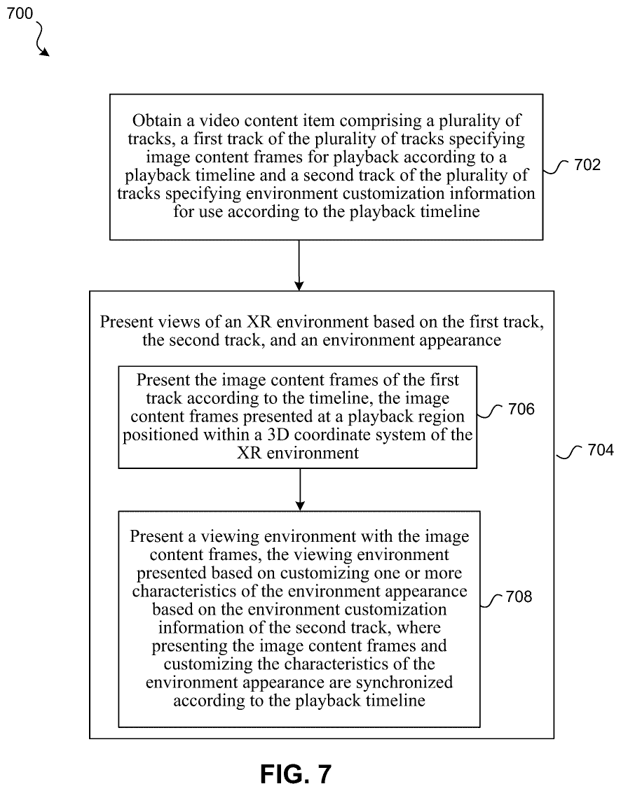

FIG. 7 is a flowchart illustrating an exemplary method of providing image content of a video content item within a content-driven viewing environment. In some implementations, the method 700 is performed by a device (e.g., device 110 of FIG. 1), such as a mobile device, desktop, laptop, or server device. The method 700 can be performed on a device that has a screen for displaying images and/or a screen for viewing stereoscopic images such as a head-mounted display (HMD). In some implementations, the method 700 is performed by processing logic, including hardware, firmware, software, or a combination thereof. In some implementations, the method 700 is performed by a processor executing code stored in a non-transitory computer-readable medium (e.g., a memory).

At block 702, the method 700 obtains a video content item comprising a plurality of tracks, a first track of the plurality of tracks specifying image content frames for playback according to a playback timeline and a second track of the plurality of tracks specifying environment customization information for use according to the playback timeline.

At block 704, the method 700 presents views of an XR environment based on the first track, the second track, and an environment appearance. The environment appearance may be a defined 3D scene, e.g., a virtual, immersive, or otherwise specified 3D environment of object. The environment appearance comprises a 3D representation of a virtual environment comprising one or more objects having 3D positions. The 3D representation may expose (e.g., provide a means of changing, for example, via an API or message interface) one or more objects for video content item-based customization. The 3D representation may expose (e.g., provide a means of changing, for example, via an API or message interface) the one or more actions associated with the objects for video content item-based customization.

The environment appearance may depict a physical environment, for example, being passthrough video of a 3D physical environment. The environment appearance may be a combination of virtual and physical environments. Thus, in some implementations, the environment appearance comprises passthrough video of a physical environment.

Presenting the views (block 704) may involve presenting the image content frames of the first track according to the timeline, the image content frames presented at a playback region (e.g., on virtual 2D screen) positioned within a three-dimensional (3D) coordinate system of the XR environment. Presenting the views (block 704) may involve presenting a viewing environment with (e.g., around) the image content frames, the viewing environment presented based on customizing one or more characteristics (e.g., objects or actions) of the environment appearance based on the environment customization information of the second track. Presenting the image content frames and customizing the characteristics of the environment appearance may be synchronized according to the playback timeline. Examples of configurations include, but are not limited to: (a) day/night transitions; (b) swapping textures of objects, walls, etc.; (c) changing a type of an environment object (e.g., dog or cat); (d) changing the position, size, shape, or aspect ratio of the video screen; (e) making hidden 2D or 3D content visible; (f) providing content instead of the video for a period of time; and (g) defining which users (e.g., in the case of shared viewing use cases) are enabled to change the environment objects/actions.

In some implementations, customizing the characteristics of the environment appearance comprises sending one or more messages to the 3D representation to affect an appearance or action of the one or more objects.

The customizing may involve, as example, a day/night transition, a texture change (e.g., of an object such as a wall, the ground, another object, etc.), or an object type change (e.g., changing a moth into a butterfly). The customization may comprises changing a position, size, shape, or aspect ratio of a virtual video screen upon which the image content frames are presented. The customization may involve enabling or disabling visibility of an object. The customization may involve enabling or disabling visibility of the image content frames. The customization may involve defining user ability of one or more users to customize the environment appearance.

The method 700 may further involve receiving input to rewind or fast-forward the image content frames according to the timeline and generating one or more modifications for the environment appearance to synchronize customization of the environment appearance according to the second track.

The customization may involve any of the other customizations described herein.

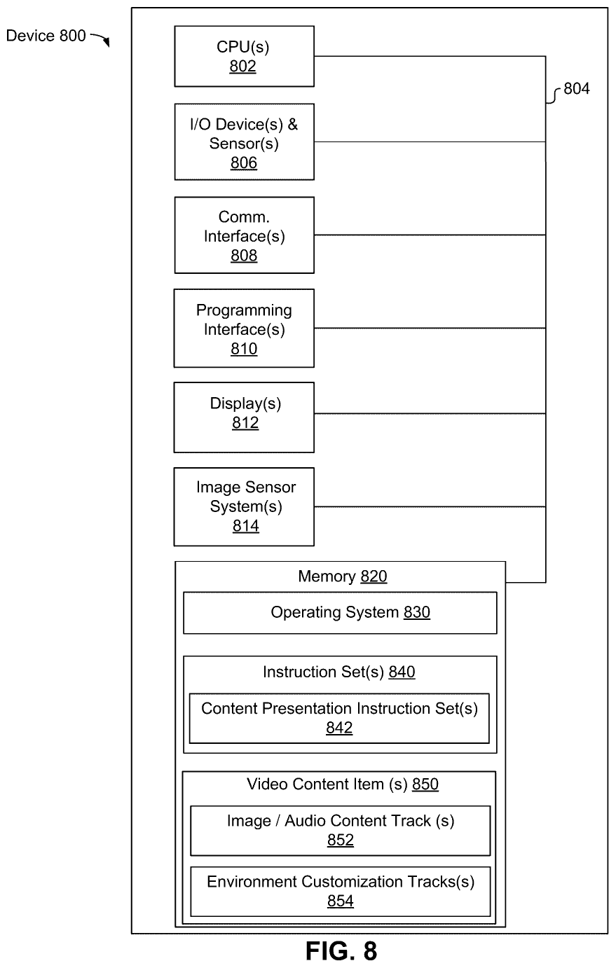

FIG. 8 is a block diagram of an example of the device 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 110 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more AR/VR displays 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, an ambient light sensor (ALS), one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 812 are configured to present the experience to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. For example, the device 110 includes a single display. In another example, the device 110 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data including at least a portion of the processes and techniques described herein.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium. In some implementations, the memory 820 or the non-transitory computer readable storage medium of the memory 820 stores the following programs, modules and data structures, or a subset thereof including an optional operating system 830 and one or more instruction set(s) 840.

The operating system 830 includes procedures for handling various basic system services and for performing hardware dependent tasks. In some implementations, the instruction set(s) 840 are configured to manage and coordinate one or more experiences for one or more users (e.g., a single experience for one or more users, or multiple experiences for respective groups of one or more users).

The instruction set(s) 840 include a content presentation instruction set 842 configured with instructions executable by a processor to provide content on a display of an electronic device (e.g., device 110). The content presentation instruction set 842 may interpret a video content item to identify video content frames to be displayed within a viewing environment that is specified and customized according to information within the video content item itself or otherwise. Such interpretation and presentation may involve any of the techniques disclosed herein.

The memory 820 may include one or more video content items 850. Such video content items 850 may each include one or more image/audio content tracks 852 with audio and video frame information and one or more environment customization tracks with viewing environment specification and customization information. Alternative formats of combining image, audio, and viewing environment information into video content items may alternatively be utilized.

Although these elements are shown as residing on a single device (e.g., the device 110), it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. For example, some functional modules (e.g., instruction set(s) 840) shown separately in FIG. 8 could be implemented in a single module and the various functions of single functional blocks (e.g., instruction sets) could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

Numerous specific details are provided herein to afford those skilled in the art a thorough understanding of the claimed subject matter. However, the claimed subject matter may be practiced without these details. In other instances, methods, apparatuses, or systems, that would be known by one of ordinary skill, have not been described in detail so as not to obscure claimed subject matter.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
at a head mounted device (HMD) having a processor:
obtaining a video content item comprising a plurality of tracks, a first track of the plurality of tracks specifying image content frames for playback according to a playback timeline and a second track of the plurality of tracks specifying environment customization information for use according to the playback timeline; and
presenting views of an extended reality (XR) environment based on the first track, the second track, and an environment appearance, wherein presenting the views comprises:
presenting the image content frames of the first track according to the timeline, the image content frames presented at a playback region positioned within a three-dimensional (3D) coordinate system of the XR environment; and
presenting a viewing environment with the image content frames, the viewing environment presented based on customizing one or more characteristics of the environment appearance based on the environment customization information of the second track,
wherein presenting the image content frames and customizing the characteristics of the environment appearance are synchronized according to the playback timeline.

2. The method of claim 1, wherein the environment appearance comprises a 3D representation of a virtual environment comprising one or more objects having 3D positions.

3. The method of claim 2, wherein the 3D representation exposes the one or more objects for video content item-based customization.

4. The method of claim 2, wherein the 3D representation exposes the one or more actions associated with the objects for video content item-based customization.

5. The method of claim 2, wherein customizing the characteristics of the environment appearance comprises sending one or more messages to the 3D representation to affect an appearance or action of the one or more objects.

6. The method of claim 1, wherein the environment appearance comprises passthrough video of a physical environment.

7. The method of claim 1, wherein the customizing comprises:
a day/night transition;
a texture change; or
an object type change.

8. The method of claim 1, wherein the customization comprises:
changing a position, size, shape, or aspect ratio of a virtual video screen upon which the image content frames are presented;
enabling visibility of an object; or
disabling visibility of the image content frames.

9. The method of claim 1, wherein the customization comprises defining user ability of one or more users to customize the environment appearance.

10. The method of claim 1 further comprising:
receiving input to rewind or fast-forward the image content frames according to the timeline; and
generating one or more modifications for the environment appearance to synchronize customization of the environment appearance according to the second track.

11. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining a video content item comprising a plurality of tracks, a first track of the plurality of tracks specifying image content frames for playback according to a playback timeline and a second track of the plurality of tracks specifying environment customization information for use according to the playback timeline; and
presenting views of an extended reality (XR) environment based on the first track, the second track, and an environment appearance, wherein presenting the views comprises:
presenting the image content frames of the first track according to the timeline, the image content frames presented at a playback region positioned within a three-dimensional (3D) coordinate system of the XR environment; and
presenting a viewing environment with the image content frames, the viewing environment presented based on customizing one or more characteristics of the environment appearance based on the environment customization information of the second track,
wherein presenting the image content frames and customizing the characteristics of the environment appearance are synchronized according to the playback timeline.

12. The system of claim 11, wherein the environment appearance comprises a 3D representation of a virtual environment comprising one or more objects having 3D positions.

13. The system of claim 12, wherein the 3D representation exposes the one or more objects for video content item-based customization.

14. The system of claim 12, wherein the 3D representation exposes the one or more actions associated with the objects for video content item-based customization.

15. The system of claim 12, wherein customizing the characteristics of the environment appearance comprises sending one or more messages to the 3D representation to affect an appearance or action of the one or more objects.

16. The system of claim 11, wherein the environment appearance comprises passthrough video of a physical environment.

17. The system of claim 11, wherein the customizing comprises:
a day/night transition;
a texture change; or
an object type change.

18. The system of claim 11, wherein the customization comprises:
changing a position, size, shape, or aspect ratio of a virtual video screen upon which the image content frames are presented;
enabling visibility of an object; or
disabling visibility of the image content frames.

19. The system of claim 11, wherein the customization comprises defining user ability of one or more users to customize the environment appearance.

20. A non-transitory computer-readable storage medium, storing program instructions computer-executable on a computer to perform operations comprising:
obtaining a video content item comprising a plurality of tracks, a first track of the plurality of tracks specifying image content frames for playback according to a playback timeline and a second track of the plurality of tracks specifying environment customization information for use according to the playback timeline; and
presenting views of an extended reality (XR) environment based on the first track, the second track, and an environment appearance, wherein presenting the views comprises:
presenting the image content frames of the first track according to the timeline, the image content frames presented at a playback region positioned within a three-dimensional (3D) coordinate system of the XR environment; and
presenting a viewing environment with the image content frames, the viewing environment presented based on customizing one or more characteristics of the environment appearance based on the environment customization information of the second track,
wherein presenting the image content frames and customizing the characteristics of the environment appearance are synchronized according to the playback timeline.
